(19) United States
(12) Patent Application Publication
(10) Pub. No.: US 2011/0024230 A1
(43) Pub. Date: Feb. 3, 2011

(54) INTERMEDIATE HOLDER FOR THE SAFETY ROPE OF AN OVERHEAD ROPE SYSTEM OF A FALL PROTECTION DEVICE AND ARRANGEMENT CONSISTING OF THE INTERMEDIATE HOLDER AND A RUNNER COOPERATING THEREWITH

(76) Inventor: Thorsten Mahr, Oberkotzau (DE)

Correspondence Address: COWAN LIEBOWITZ & LATMAN P.C, 1133 AVENUE OF THE AMERICAS, 1133 AVENUE OF THE AMERICAS, NEW YORK, NY, 10036, US

(21) Appl. No.: 12/935,047

(22) PCT Filed: Mar. 27, 2009
(86) PCT No.: PCT/EP09/53656

§ 371 Date: Sep. 28, 2010

(30) Foreign Application Priority Data
Mar. 28, 2008 (DE) 20 2008 004 254.2

(51) Int. Cl. E04G 21/32; F16L 3/00; A62B 35/00

(52) U.S. Cl. 182/36; 248/65

(57) ABSTRACT

The intermediate holder (10) for a safety rope (38) of an overhead safety rope system comprises a base (12) and a yoke (14) which bears a guide tube (16), in which the safety rope (38) can be secured, and which is articulated at its upper end on the base (12) at an articulation point. At its lower end, the yoke (14) supports the guide tube (16) from below at an angle of 0 to 90° to the connection line between the articulation point of the yoke (14) on the base (12) and the guide tube (16). The yoke (14) is cut out in the form of a C such that it can grip laterally around a runner (40) guided on the safety rope (38). In an arrangement consisting of the intermediate holder and a runner (40) cooperating therewith, the runner (40) has two side parts (42, 44) between which at least one running roller (46) is mounted, wherein one of the two side parts (42) grips around the running roller (46) on the underside at a distance (56) which is slightly larger than the diameter of the guide tube (16), and wherein a gap (60) for the passage of the lower end (36) of the yoke (14) remains free between the lower ends of the side parts (42, 44). Preferably, two running rollers (46, 48) are mounted between the side parts (42, 44).

### TECHNICAL FIELD

The invention relates to an intermediate holder for a safety rope of an overhead rope system of a fall protection device. The intermediate holder has a base and a C-shaped yoke which bears a guide tube in which the safety rope is held. At its top end the yoke is hinged to the base at a point of articulation.

The intermediate holder is part of a horizontal safety system which is composed of a safety rope which is attached by means of end holders and intermediate holders to a structure, a platform, a gantry or similar, and a runner guided on the rope, to which the person to be secured is fastened by means of his personal safety equipment. The runner runs on the safety rope by means of a guide pulley. On the one hand, it must be secured to the rope such that, even if the rope vibrates it cannot detach itself from it, and on the other hand it must be designed such that it can travel over the guide tube. In order to meet both conditions very laborious solutions are known from the state of the art. Additionally, the intermediate holder and the runner must be designed such that they can travel over the intermediate holder even if the person to be secured is not located precisely vertically under the intermediate holder.

### STATE OF THE ART

Such an intermediate holder is known from GB 2 199 880. The guide tube is suspended from the yoke by means of two spaced webs. The runner guided on the safety rope accordingly has a slit on its top side with which it can travel over the webs between the yoke and the guide tube. By being hinged to the base the yoke pivots according to the force exerted on it by the runner with the result that the slit in the runner aligns approximately with the webs. In order to prevent the runner from detaching itself from the guide rope because of this slit, a section of tube which on its top side has an arc-shaped slit is rotatably housed in the runner, with the result that the slit in the guide tube is not completely aligned with the slit in the runner. If the runner is to travel over the intermediate holder, the guide tube rotates by a few degrees in one and then the other direction according to its arc shape.

An intermediate holder and a runner for an overhead rope security system are known from U.S. Pat. No. 6,488,118, wherein the intermediate holder has a base and a yoke which bears a guide tube in which the safety rope can be fixed. The yoke is rigidly connected to the base and supports the guide tube diagonally from below at an angle of approximately 10° to the horizontal.

An anchoring system for an overhead rope system of a fall protection device is known from EP 1 733 763 A1, in which the runner has a C-shaped body with a lateral opening which encloses a duct for the safety rope. The runner can be fitted onto the safety rope through the lateral opening. The guide tube is held by a horizontal yoke. The lateral opening also serves to travel over this yoke. In order to prevent an unintentional loosening from the safety rope, the lateral opening is partly closed by spring-loaded closing elements to the extent that the runner can still travel over the horizontal yoke. A similar intermediate holder is known from DE 694 02 442 T2 (=EP 0 608 164 B1), wherein here the opening points diagonally downwards.

An intermediate holder for a safety rope of an overhead rope system of a fall protection device which consists of a section of tube with side slits in which the safety rope is loosely held is known from U.S. Pat. No. 5,279,385, FIG. 11. The runner is C-shaped and can travel over the intermediate holder through the slit. The intermediate holder is hinged to a yoke.

### DESCRIPTION OF THE INVENTION

### Technical Problem

The object of the invention is to provide an intermediate holder with which the intermediate holder can be passed over even if the person to be secured is not located precisely vertically under the intermediate holder, and which is simple in design.

### Technical Solution

According to the invention this object is achieved in an intermediate holder with the features named at the beginning, by the yoke supporting the guide tube from below, at its bottom end, at an angle of 0 to 90° to the line connecting the point of articulation of the yoke to the base and the guide tube.

Preferably the yoke supports the guide tube from below at an angle of approximately 45° to the line connecting the point of articulation of the yoke at the base and the guide tube.

### Advantageous Effects

By hinging the C-shaped yoke to the base the C-shaped yoke necessarily pivots such that the line connecting the articulation axis of the C-shaped yoke to the base and the guide tube is aligned according to the force which is exerted on the runner by the person secured by means of the gripping device. If the runner travels over the guide tube, it is therefore always found in approximately the same position vis-à-vis the C-shaped yoke, namely parallel thereto.

The runner has at least one castor which is housed on a journal which is attached to the top end of a first side part. An eye which forms the point of attachment and lies in the centre plane of the at least one castor is provided at the bottom end of the first side part. In order to prevent the castor from sliding off the safety rope, the first side part is bent round below the castor with a distance between the castor and its centre plane such that the guide tube can be passed over at a small distance. A second, downward pointing side part is arranged at the free end of the journal. A slit a few millimetres wide running in longitudinal direction i.e. parallel to the safety rope, is located between the bent round part of the first side part and the bottom end of the second side part. Immediately before the guide tube, the C-shaped yoke has a flat shape or flattened section, likewise pointing in longitudinal direction, i.e. parallel to the safety rope. The runner with its slit passes over this flat section between the first side part and the second side part. As the C-shaped yoke and the runner are normally always aligned parallel to each other, when travelling over the guide tube with its slit the runner strikes the flat section of the C-shaped yoke, with the result that the runner can pass over the intermediate holder. A slight widening of the slit at both its ends may still be expedient. The width of the slit is clearly smaller than the diameter of the safety rope, with the result that, even if the safety rope vibrates, the runner cannot detach itself from it or lift up from it.

The subject of the invention is also an arrangement which is composed of the intermediate holder according to the invention and the runner cooperating therewith. The runner has two side parts between which at least one castor is housed, wherein one of the two side parts grips round the castor on the bottom side at a distance which is slightly greater than the diameter of the guide tube and wherein between the bottom ends of the side parts a gap remains free for passing over the bottom end of the yoke.

The runner preferably has two castors arranged one behind the other. The runner is stabilized on the safety rope and the guide tube by two castors with the result that the runner does not oscillate on the safety rope, the guide tube and its chamfered sections. The gap thereby reliably aligns with the side parts of the runner with the flat end supporting the guide tube of the C-shaped yoke and the danger of the runner remaining suspended from the intermediate holder when passing over it is substantially reduced. The runner is very smoothly guided on the guide tube by the two castors, with the result that it is sufficient if the gap is slightly larger than the thickness of the flat, cantileverend of the C-shaped yoke. The detachment of the runner from the safety rope is thereby reliably prevented.

The intermediate holder and the runner are made from metal, preferably special steel.

### BRIEF DESCRIPTION OF THE DRAWINGS

An embodiment example of the invention is described below in more detail with the help of the drawing. There are shown in:

FIG. 1 the intermediate holder in a three-dimensional representation;

FIG. 2 the intermediate holder from FIG. 1 in an exploded view;

FIG. 3 the intermediate holder and the runner looking towards the safety rope;

FIG. 4 the intermediate holder and the runner from the side;

FIG. 5 the intermediate holder and the runner when pulled strongly sideways; and

FIG. 6 the intermediate holder and the runner from the side as the runner runs onto the chamfered section of the guide tube.

### WAY(S) OF CARRYING OUT THE INVENTION

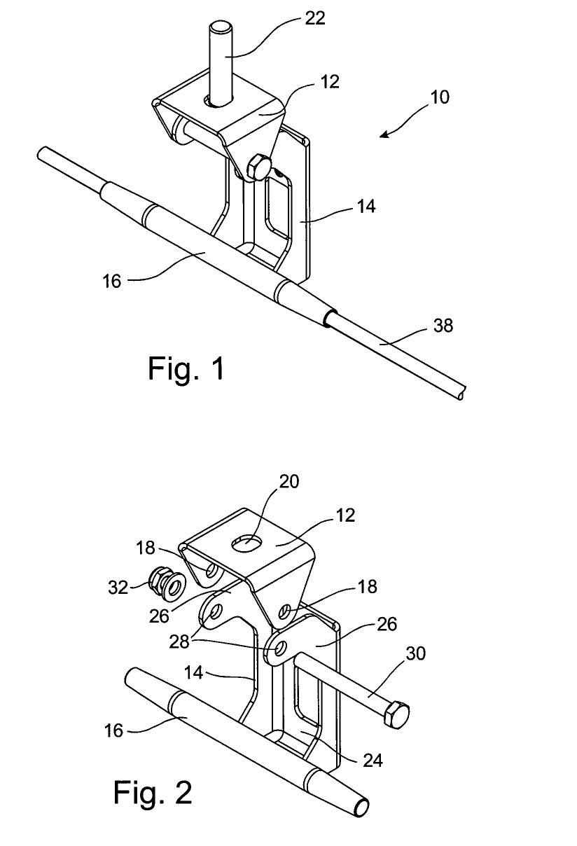

FIGS. 1 and 2 show an intermediate holder 10 of an overhead safety system. The intermediate holder 10 consists of a fastening base 12, a C-shaped yoke 14 and a guide tube 16. The fastening base 12 is a U-shaped yoke with two aligned bores 18 at the ends of the U-shaped sides. The fastening base 12 has a bore 20 in its middle piece, with the result that it can be fastened by a pin or a screw to a latticed structure or masonry. The yoke 14 has two opposing side surfaces or cheeks 26 bent from a central area 24 with aligned bores 28 at the top end. The C-shaped yoke 14 is hinged to the fastening base 12 by means of a threaded bolt 30 which is inserted through the aligned bores 18 and 28 of the fastening base 12 and of the yoke 14. A stop nut 32 is screwed onto the end of the threaded bolt 30.

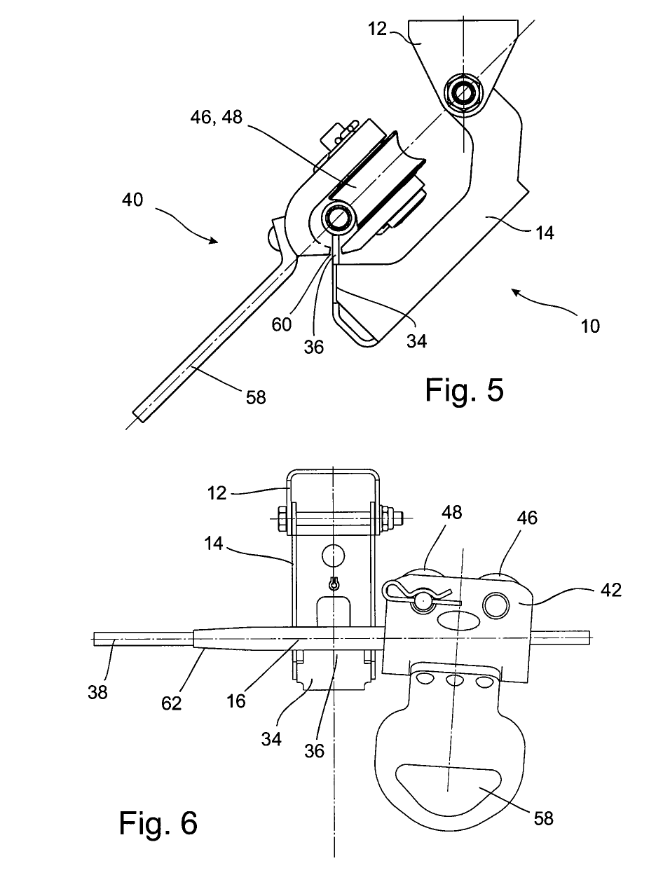

The cheeks 26 of the yoke 14 are relieved in the central area and as a result have, in FIGS. 1 to 13, the shape of a C open to the left. The central area 24 of the yoke 14 bent downwards by 135° at the bottom end and the start of the section 34 running diagonally upwards is welded laterally to the bottom ends of the cheeks 26 and reinforced as a result. Further along, the section 34 aligned diagonally upwards is cantilever and the guide tube 16 is welded to its end 36. The cantilever end 36 of the section 34 has a flat profile lying in the direction of the guide tube 16. The guide tube 16 is aligned parallel to the threaded bolt 30 and has a long central area with a load-bearing cross-section and two shorter chamfered sections 62 at its ends. The safety rope 38 can move freely in longitudinal direction in the guide tube 16. The inner diameter of the guide tube 16 is greater than the diameter of the safety rope 38.

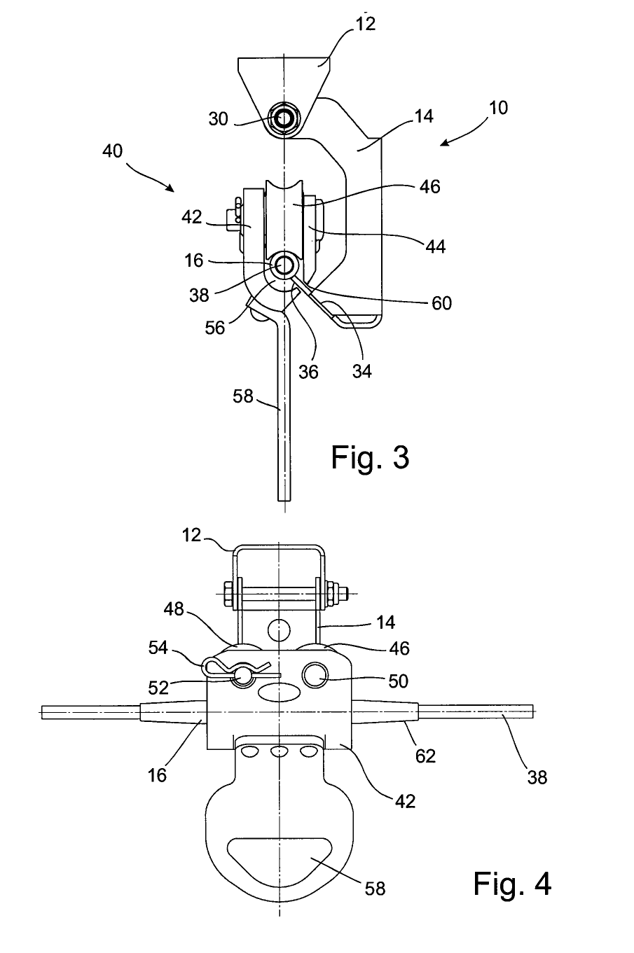

A runner 40 running on the safety rope 38 is shown in FIGS. 3 to 6. The runner 40 has a first side part 42 and a second side part 44 between which two castors are housed at 46 and 48. The castors 46, 48 sit on journals 50, 52, wherein the journal 50 of the first castor is pressed into the first side part 42 and the journal 52 of the second castor 48 into the second side part 44. The journal 50 of the first castor 46 is guided through a corresponding bore in the second side part 44 and secured outside by means of a splint 54. Conversely, the journal 52 of the second castor 48 is guided through a bore in the first side part 42 and secured outside by means of a splint 54. Otherwise there is no link between the first side part 42 and the second side part 44. At the bottom end, the first side part 42 is guided around the castors 46, 48 by something more than 90° at a distance 56 which is slightly larger than the diameter of the guide tube 16. An eye 58 is spotwelded to the first side part 42 in the region of the bend and bent vertically downwards. The vertically downwardly directed part of the eye 58 lies in the centre plane of the castors 46, 48.

A horizontal gap or slit 60, which passes over the cantilever end 36 of the section 34 when the runner 40 travels over the guide tube 16 is situated below the bottom rim of the second side part 44 and the slightly upwards-pointing end of the bend of the first side part 42. The yoke 14 grips laterally round the runner 40 through its C-shaped cut-out form, with the result that the runner 40 does not collide with the yoke 14.

If the person secured to the runner 40 is not standing precisely vertically under the safety rope 38, but standing slightly to one side of it, the force exerted on the runner 40 has a corresponding lateral component. The yoke 14 then pivots such that the line connecting the axis of the threaded bolt 30 and the axial centre of the guide tube 16 points in the direction of the force exerted on the runner 40. This connection line also lies in the centre plane of the castors 46, 48. Therefore, the alignment of the runner 40 vis-à-vis the yoke 14 of the intermediate holder 10 remains unchanged, seen in longitudinal direction of the guide tube 16 and in particular does not depend on the position of the person secured, with the result that the gap or slit 60 of the runner 40 reliably registers with the cantilever, flat end 36 of the section 34 and the runner 40 can pass over the intermediate holder 10. The slit 60 therefore need be only slightly wider than the cantilever end 36 of the section 34.

The guide tube 16 has a central area with a uniform, load-bearing cross-section and chamfered sections 62 at both ends. When the runner runs up to the chamfered section 62, the runner 40 tips slightly (FIG. 6), with the result that the gap 60 no longer aligns precisely with the flat, cantilever end of the section 34. At the beginning and the end, the slit 60 is therefore slightly widened in order to ensure that the gap 60 strikes the flat end of the section 34. As two spaced castors 46, 48 are provided, the runner 40 does not oscillate on the safety rope 38, the guide tube 16 and its chamfered sections 62, whereby it is likewise ensured that the runner 40 with its slit 60 registers with the flat end of the section 34. The runner is very smoothly guided on the guide tube by the two castors 46, 48, with the result that it is sufficient if the gap 60 is slightly larger than the thickness of the flat, cantilever end 36 of the section 34. The detachment of the runner 40 from the safety rope 38 is thereby reliably prevented.

### LIST OF REFERENCE NUMBERS

10 Intermediate holder
12 Fastening base
14 C-shaped yoke
16 Guide tube
18 Bore
20 Bore
22 Screw
24 Central area
26 Cheeks
28 Bore
30 Threaded bolt
32 Stop nut
34 Section
36 End
38 Safety rope
40 Runner
42 First side part
44 Second side part
46 First castor
48 Second castor
50 Journal
52 Journal
54 Splint
56 Distance
58 Eye
60 Gap, slit
62 Chamfered section

1-5. (canceled)

6. An intermediate holder for a safety rope of an overhead rope safety system comprising:
a base;
a yoke which has a bottom end and a top end and which at its top end is hinged to the base at a point of articulation;
a guide tube which is born by the yoke at said bottom end of the yoke and which is adapted to secure the safety rope;
wherein the yoke supports at its bottom end the guide tube from below at an angle of 0 to 90° to the line connecting the point of articulation of the yoke to the base and the guide tube.

7. The intermediate holder according to claim 6, wherein the yoke supports the guide tube from below at an angle of approximately 45° to the line connecting the point of articulation of the yoke at the base and the guide tube.

8. The intermediate holder according to claim 6, wherein the yoke is cut out in a C-shape, with the result that it is adapted to laterally grip round a runner when the runner is guided on the safety rope.

9. The intermediate holder according to claim 7, wherein the yoke is cut out in a C-shape, with the result that it is adapted to laterally grip round a runner when the runner is guided on the safety rope.

10. A system including an intermediate holder for a safety rope of an overhead rope safety system and a runner cooperating with the intermediate holder, the intermediate holder comprising:
a base;
a yoke which has a bottom end and a top end and which at its top end is hinged to the base at a point of articulation;
a guide tube which is born by the yoke at said bottom end of the yoke and which adapted to secure the safety rope;
wherein the yoke supports at its bottom end the guide tube from below at an angle of 0 to 90° to the line connecting the point of articulation of the yoke to the base and the guide tube; and
wherein the runner has two side parts, between which at least one castor is housed, one of the two side parts gripping round the castor on the bottom side at a distance which is slightly greater than the diameter of the guide tube, and wherein a gap remains free between the bottom ends of the side parts for passing the bottom end of the yoke.

11. The system according to claim 10, wherein two castors are housed between the side parts.
